(19) United States
(12) Patent Application Publication
(10) Pub. No.: US 2005/0127874 A1
(43) Pub. Date: Jun. 16, 2005

(54) Method and apparatus for multiple battery cell management

(76) Inventors: Myoungho Lim, Dong-ku (KR); Mark J. Flaherty, Colorado Springs, CO (US); Woo-chul Yi, Colorado Springs, CO (US); Keith Griffin, Chipita Park, CO (US)

Correspondence Address: CANTOR COLBURN, LLP, 55 GRIFFIN ROAD SOUTH, BLOOMFIELD, CT, 06002, US

(21) Appl. No.: 10/735,010

(22) Filed: Dec. 12, 2003

(51) Int. Cl. H02J 7/00

(52) U.S. Cl. 320/128

(57) ABSTRACT

Embodiments of the present invention are directed to a method and apparatus for multiple battery cell management. In one embodiment, a solid state relay is used instead of a mechanical relay in a BMS. The SSR is smaller and faster than a mechanical relay, enabling smaller BMSs that more efficiently and safely manage battery cell charge. In another embodiment, a plurality of battery cells are connected to two rails, using four SSRs to control access to the battery cells. In one embodiment, a plurality of battery cells are grouped together and controlled as one module of a multi-module BMS. In one embodiment, each module has 10 battery cells in series. In one embodiment, the BMS controls 4 modules. In one embodiment, each module is controlled by control signals passing through logical gates. In another embodiment, each module is controlled by control signals passing through a programmed circuit.

### BACKGROUND OF THE INVENTION

1. Field of the Invention

The present invention relates to the field of multiple battery systems, and in particular to a method and apparatus for multiple battery cell management.

2. Background Art

Recently, several types of batteries have been developed for electrical, hybrid electrical vehicles, and launch assistant 42V battery applications. LiPb has a higher energy density than other batteries developed so far, but it has stringent management requirements for safety and extension of battery life. Balancing the cells, estimating the state of charge (SOC), and controlling temperature require a very sophisticated Battery Management System (BMS). This problem can be better understood with a review of multiple battery systems.

Multiple Battery Systems

Some systems connect a plurality of battery cells in series. Typically, the cells in series are charged collectively rather than individually. However, LiPb batteries may ignite if overcharged. Thus, it is desirable to not overcharge any individual cell and to keep the individual cells' SOC well-balanced. The voltage of a battery is a good indicator of the battery's SOC.

By measuring each battery's SOC, a BMS can reduce or boost the SOC of an individual battery as needed. To control its operations, BMSs employ mechanical relays in their circuitry. In a typical mechanical relay, control signals control an electromagnet that attracts or repels an armature. When the armature is in one position, a circuit is open, but when the electromagnet causes the armature to move to a second position, the circuit is closed. Thus, during normal operation of a BMS, mechanical opening and closing of circuits is used to control battery charge. However, mechanical relays are relatively large and slow. Thus, BMSs are larger than desired, and may not be able to respond quickly enough to ensure safe and efficient operation of multiple battery cell systems.

### SUMMARY OF THE INVENTION

Embodiments of the present invention are directed to a method and apparatus for multiple battery cell management. In one embodiment of the present invention, a solid state relay (SSR) is used instead of a mechanical relay in a BMS. The SSR is smaller and faster than a mechanical relay, enabling smaller BMSs that more efficiently and safely manage battery cell charge. In another embodiment, a plurality of battery cells are connected to two rails, using four SSRs to control access to the battery cells.

In one embodiment, a plurality of battery cells are grouped together and controlled as one module of a multi-module BMS. In one embodiment, each module has 10 battery cells in series. In other embodiments, other numbers and arrangements of batteries are used. The modular design enables more efficient scaling of the BMS. In one embodiment, the BMS controls 4 modules. In other embodiments, the BMS controls other numbers of modules. In one embodiment, each module is controlled by control signals passing through logical gates. In another embodiment, each module is controlled by control signals passing through a programmed circuit (e.g., an EPROM or Programmed Logic Array).

### BRIEF DESCRIPTION OF THE DRAWINGS

These and other features, aspects and advantages of the present invention will become better understood with regard to the following description, appended claims and accompanying drawings where:

FIG. 1 is a block diagram of a two rail multiple battery cell system in accordance with one embodiment of the present invention.

FIG. 2 is a flow diagram of the process of performing a read operation using the system of FIG. 1 in accordance with one embodiment of the present invention.

FIG. 3 is a flow diagram of the process of performing a buck operation using the system of FIG. 1 in accordance with one embodiment of the present invention.

FIG. 4 is a flow diagram of the process of performing a boost operation using the system of FIG. 1 in accordance with one embodiment of the present invention.

FIG. 5 is a flow diagram of a BMS module that is controlled by an 8 bit control logic circuit in accordance with one embodiment of the present invention.

FIG. 6 is a flow, diagram of a BMS module that is controlled by an 8 bit control logic together with a PLA or EPROM in accordance with one embodiment of the present invention.

FIG. 7 is a block diagram of the response times achieved using SSRs in a BMS in accordance with one embodiment of the present invention.

### DETAILED DESCRIPTION OF THE INVENTION

The invention is a method and apparatus for multiple battery cell management. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

Solid State Relays

In one embodiment of the present invention, a solid state relay (SSR) is used instead of a mechanical relay in a BMS. The SSR is smaller and faster than a mechanical relay, enabling smaller BMSs that more efficiently and safely manage battery cell charge. In one embodiment, the solid state relay is an optically isolated field-effect transistor (FET). In one embodiment, the input level for controlling the SSR is matched to the voltage level of the control circuit (e.g., 5V and 0V). In one embodiment, the SSR insulates the control circuitry from the higher voltage potentials of the battery cells. In another embodiment, current is able to flow bi-directionally through the SSR. In one embodiment, the current flow through the SSR is limited to 130 mA. In another embodiment, the SSR has low resistance and little or no potential drop.

In one embodiment, in order to read the voltage of each cell through the switching device correctly, the switching device does not consume the potential. In an example embodiment, the device has a turn on voltage of 0.9V. In another example embodiment, during boosting operations, since the voltage of a DC/DC converter is 12V and the cell voltage is 3V to 4.2V, 7.8V difference in potential remains with 130 mA current flow allowance. Thus, in this embodiment, the total resistance of current path for boosting is less than 60 ohms. In one embodiment wherein 5 switching devices are used, the turn on resistance is less than 12 ohms.

In one embodiment, during bucking operations, the voltage range of a single cell is 3V to 4.2V and the required current is 130 mA. In this embodiment, the total resistance of current path for bucking is less than 23 ohms to 32 ohms. In another embodiment wherein 5 switching devices are used, the turn on resistance is less than 5 ohms to 6 ohms.

Two Rail Access to Battery Cells

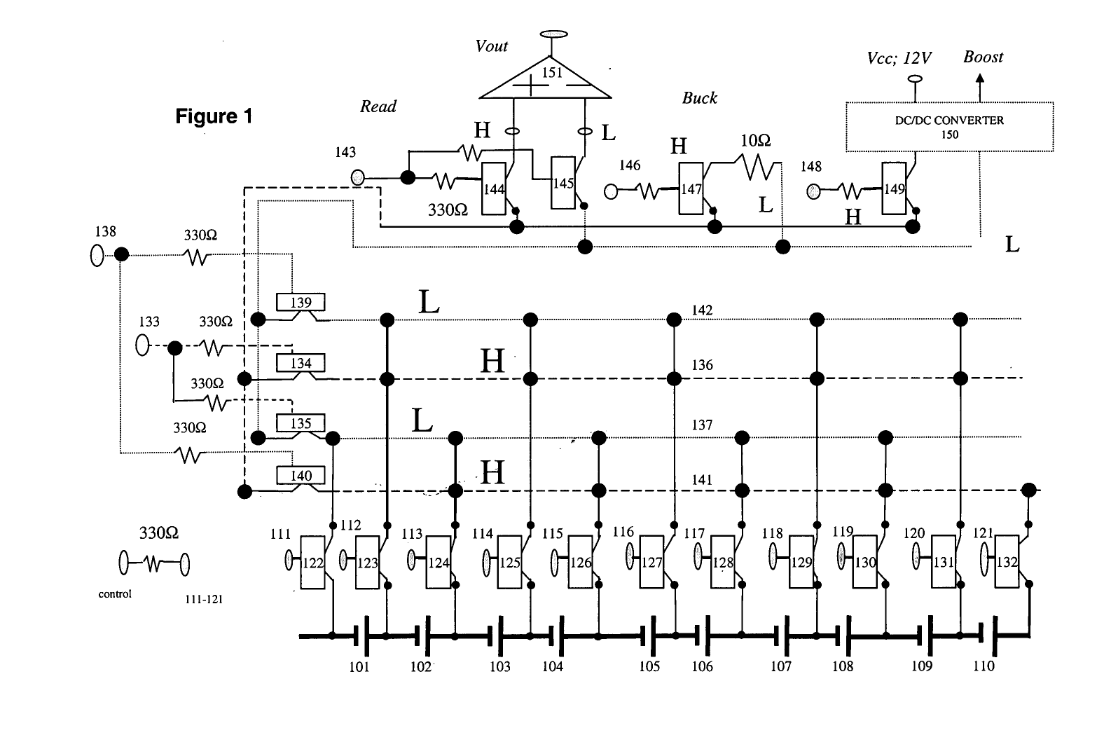

In another embodiment, a plurality of battery cells are connected to two rails, using four SSRs to control access to the battery cells. FIG. 1 illustrates a two rail multiple battery cell system in accordance with one embodiment of the present invention. The system has battery cells 101 through 110 in series and 16 control inputs. Inputs 111 to 121 control switches 122 to 132, respectively, and the resistance between the control signal and inputs 111 to 121 is 330 Ohms. These controls are used to select a battery cell for an operation by the BMS. For example, to select battery cell 105, switches 126 and 127 would be on while the other switches would be off.

Input 133 controls switches 134 and 135 of a first rail having a high line 136 and low line 137. This control is used to select which rail is used to access the battery cells for an operation by the BMS. When switches 134 and 135 are on, the first rail is used, and as a result, an odd numbered battery cell is being accessed by the BMS.

Input 138 controls switches 139 and 140 of a second rail having a high line 141 and low line 142. This control is also used to select which rail is used to access the battery cells for an operation by the BMS. When switches 139 and 140 are on, the second rail is used, and as a result, an even numbered battery cell is being accessed by the BMS.

Input 143 controls switches 144 and 145. This control is used when the BMS is performing a read operation. Input 146 controls switch 147. This control is used when the BMS is performing a buck operation. Input 148 controls switch 149. This control is used when the BMS is performing a boost operation.

Switch 122 is electrically connected to the low potential side of battery cell 101 and when on connects that point to the low line 137 of the first rail. Switch 123 is electrically connected between battery cells 101 and 102, and when on connects that point to the high line 136 of the first rail and the low line 142 of the second rail. Switch 124 is electrically connected between battery cells 102 and 103, and when on connects that point to the high line 141 of the second rail and the low line 137 of the first rail. Switch 125 is electrically connected between battery cells 103 and 104, and when on connects that point to the high line 136 of the first rail and the low line 142 of the second rail. Switch 126 is electrically connected between battery cells 104 and 105, and when on connects that point to the high line 141 of the second rail and the low line 137 of the first rail.

Switch 127 is electrically connected between battery cells 105 and 106, and when on connects that point to the high line 136 of the first rail and the low line 142 of the second rail. Switch 128 is electrically connected between battery cells 106 and 107, and when on connects that point to the high line 141 of the second rail and the low line 137 of the first rail. Switch 129 is electrically connected between battery cells 107 and 108, and when on connects that point to the high line 136 of the first rail and the low line 142 of the second rail. Switch 130 is electrically connected between battery cells 108 and 109, and when on connects that point to the high line 141 of the second rail and the low line 137 of the first rail.

Switch 131 is electrically connected between battery cells 109 and 110, and when on connects that point to the high line 136 of the first rail and the low line 142 of the second rail. Switch 132 is electrically connected to the high potential side of battery cell 110, and when on connects that point to the high line 141 of the second rail.

Switch 134, when on, connects the high line 136 of the first rail to switches 144, 147 and 149. Switch 135, when on, connects the low line 137 of the first rail to switches 145 and 147 and to DC/DC converter 150. A 10 Ohm resistor is between switches 135 and 147. Switch 140, when on, connects the high line 141 of the second rail to switches 144, 147 and 149. Switch 139, when on, connects the low line 142 of the second rail to switches 145 and 147 and to DC/DC converter 150. A 10 Ohm resistor is between switches 139 and 147. The DC/DC converter 150 is also connected to a voltage source.

Switch 144, when on, connects switches 134 and 140 to a high input of voltage differentiator 151. Switch 145, when on, connects switches 135 and 139 to a low input of voltage differentiator 151. Switch 147, when on, connects switches 134 and 140 to switches 135 and 139. Switch 149, when on, connects switches 134 and 140 to DC/DC converter 150. Appendix A illustrates bit patterns and timing values associated with the BMS system of FIG. 1.

Read Operation

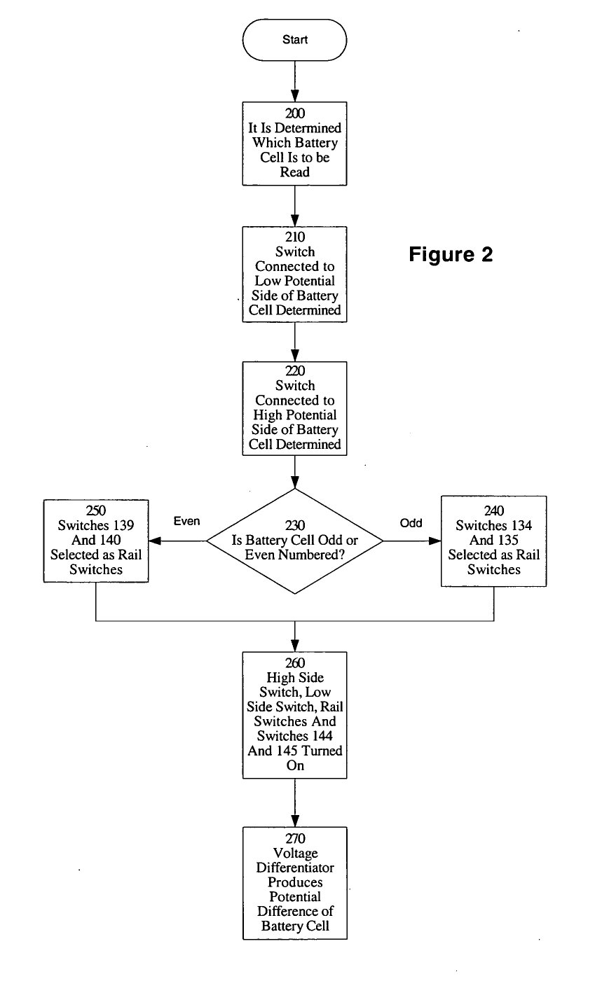

FIG. 2 illustrates the process of performing a read operation using the system of FIG. 1 in accordance with one embodiment of the present invention. A read operation is performed to determine the SOC of a battery cell. At block 200, it is determined which battery cell is to be read. At block 210, the switch connected to the low potential side of the battery cell is determined. At block 220, the switch connected to the high potential side of the battery cell is determined. At block 230, it is determined whether the battery cell is odd or even numbered. If the battery cell is odd numbered, at block 240, switches 134 and 135 are selected as the rail switches and the process continues at block 260. If the battery cell is even numbered, at block 250, switches 139 and 140 are selected as the rail switches. The determinations of blocks 210 through 250 are made in various orders, including in parallel, in various embodiments of the present invention.

At block 260, the high side switch, low side switch, rail switches and switches 144 and 145 are turned on. All other switches are off. Thus, the high potential side of the battery cell is connected to the high input of the voltage differentiator and the low potential side of the battery cell is connected to the low input of the voltage differentiator. At block 270, the voltage differentiator produces the potential difference of the battery cell.

Buck Operation

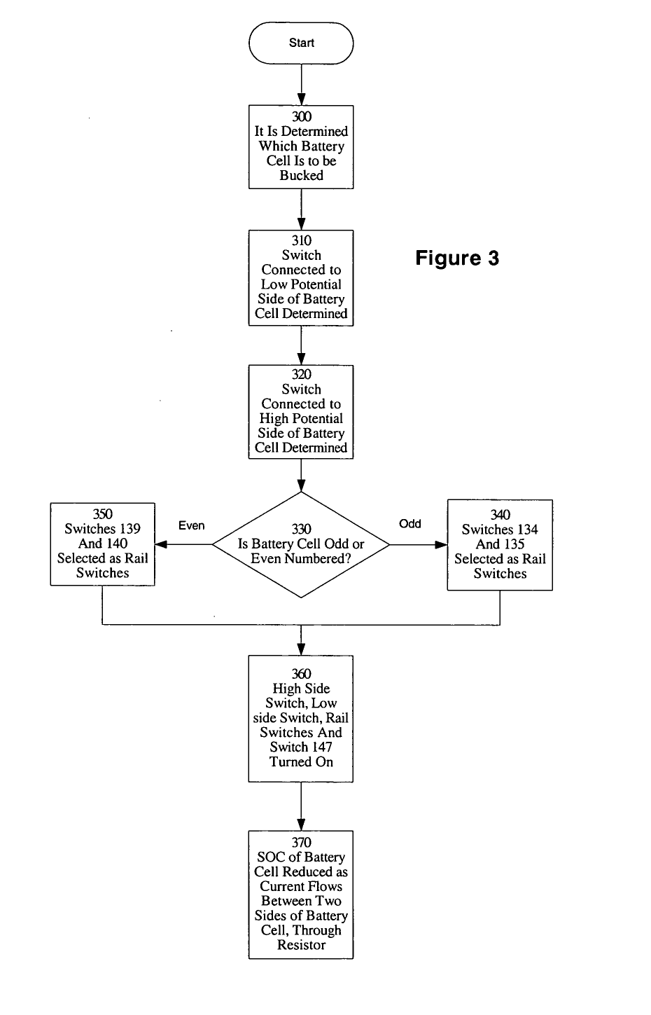

FIG. 3 illustrates the process of performing a buck operation using the system of FIG. 1 in accordance with one embodiment of the present invention. A buck operation is performed to reduce the SOC of a battery cell. At block 300, it is determined which battery cell is to be bucked. At block 310, the switch connected to the low potential side of the battery cell is determined. At block 320, the switch connected to the high potential side of the battery cell is determined. At block 330, it is determined whether the battery cell is odd or even numbered. If the battery cell is odd numbered, at block 340, switches 134 and 135 are selected as the rail switches and the process continues at block 360. If the battery cell is even numbered, at block 350, switches 139 and 140 are selected as the rail switches. The determinations of blocks 310 through 350 are made in various orders, including in parallel, in various embodiments of the present invention.

At block 360, the high side switch, low side switch, rail switches and switch 147 are turned on. All other switches are off. Thus, the high potential side of the battery cell is connected to the low potential side of the battery cell with a resistor between the two. In various embodiments, the resistance value is varied. At block 370, the SOC of the battery cell is reduced as current flows between the two sides of the battery cell, through the resistor.

Boost Operation

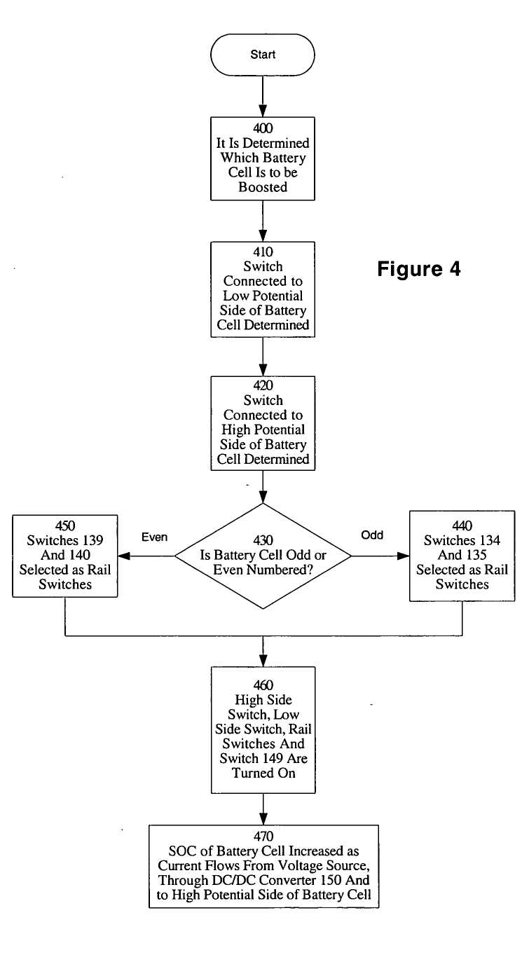

FIG. 4 illustrates the process of performing a boost operation using the system of FIG. 1 in accordance with one embodiment of the present invention. A boost operation is performed to increase the SOC of a battery cell. At block 400, it is determined which battery cell is to be boosted. At block 410, the switch connected to the low potential side of the battery cell is determined. At block 420, the switch connected to the high potential side of the battery cell is determined. At block 430, it is determined whether the battery cell is odd or even numbered. If the battery cell is odd numbered, at block 440, switches 134 and 135 are selected as the rail switches and the process continues at block 460. If the battery cell is even numbered, at block 450, switches 139 and 140 are selected as the rail switches. The determinations of blocks 410 through 450 are made in various orders, including in parallel, in various embodiments of the present invention.

At block 460, the high side switch, low side switch, rail switches and switch 149 are turned on. All other switches are off. Thus, the high and low potential sides of the battery cell are connected to the DC/DC converter. At block 470, the SOC of the battery cell is increased as current flows from the voltage source, through the DC/DC converter 150 and to the high potential side of the battery cell.

Scalable Modular BMS

In one embodiment, a plurality of battery cells are grouped together and controlled as one module of a multi-module BMS. In one embodiment, each module has 10 battery cells in series. In other embodiments, other numbers and arrangements of batteries are used. The modular design enables more efficient scaling of the BMS. In one embodiment, the system of FIG. 1 is a module. In one embodiment, the BMS controls 4 modules. In other embodiments, the BMS controls other numbers of modules.

Control Logic

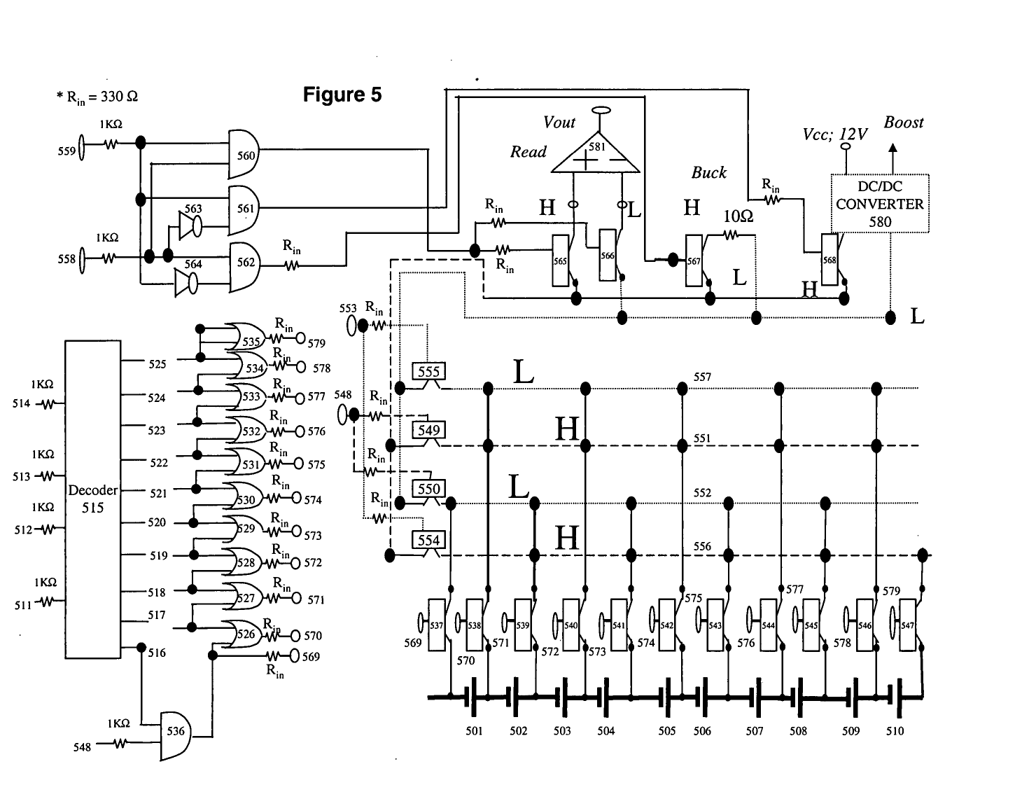

In one embodiment, each module is controlled by control signals passing through logical gates. In another embodiment, each module is controlled by control signals passing through a programmed circuit (e.g., an EPROM or Programmed Logic Array). In one embodiment, the system of FIG. 1 is controlled by a 16 bit control logic circuit. FIG. 5 illustrates a BMS module that is controlled by an 8 bit control logic circuit in accordance with one embodiment of the present invention.

The module has battery cells 501 through 510 in series and 8 control inputs. Inputs 511 to 514 connect to decoder 515. Decoder 515 has 10 outputs 516 to 525. Outputs 516 to 525, together with OR gates 526 to 535 and AND gate 536, control switches 537 to 547. Input 548 connects to AND gate 536 and controls switches 549 and 550 of a first rail having a high line 551 and low line 552. Input 553 controls switches 554 and 555 of a second rail having a high line 556 and low line 557. Inputs 558 and 559 are used together with AND gates 560 to 562 and NOT gates 563 and 564 to control switches 565 to 568.

Output 516 connects to AND gate 536. The output from AND gate 536 connects to OR gate 526 and is also input 569, which controls switch 537. Output 517 connects to OR gates 526 and 527. The output from OR gate 526 is input 570, which controls switch 538. Output 518 connects to OR gates 527 and 528. The output from OR gate 527 is input 571, which controls switch 539. Output 519 connects to OR gates 528 and 529. The output from OR gate 528 is input 572, which controls switch 540. Output 520 connects to OR gates 529 and 530. The output from OR gate 529 is input 573, which controls switch 541. Output 521 connects to OR gates 530 and 531. The output from OR gate 530 is input 574, which controls switch 542. Output 522 connects to OR gates 531 and 532. The output from OR gate 531 is input 575, which controls switch 543. Output 523 connects to OR gates 532 and 533. The output from OR gate 532 is input 576, which controls switch 544. Output 524 connects to OR gates 533 and 534. The output from OR gate 533 is input 577, which controls switch 545. Output 525 connects to OR gate 534 and to both inputs of OR gate 535. The output from OR gate 534 is input 578, which controls switch 546. The output from OR gate 535 is input 579, which controls switch 547.

Switch 537 is electrically connected to the low potential side of battery cell 501 and when on connects that point to the low line 552 of the first rail. Switch 538 is electrically connected between battery cells 501 and 502, and when on connects that point to the high line 551 of the first rail and the low line 557 of the second rail. Switch 539 is electrically connected between battery cells 502 and 503, and when on connects that point to the high line 556 of the second rail and the low line 552 of the first rail. Switch 540 is electrically connected between battery cells 503 and 504, and when on connects that point to the high line 551 of the first rail and the low line 557 of the second rail. Switch 541 is electrically connected between battery cells 504 and 505, and when on connects that point to the high line 556 of the second rail and the low line 552 of the first rail.

Switch 542 is electrically connected between battery cells 505 and 506, and when on connects that point to the high line 551 of the first rail and the low line 557 of the second rail. Switch 543 is electrically connected between battery cells 506 and 507, and when on connects that point to the high line 556 of the second rail and the low line 552 of the first rail. Switch 544 is electrically connected between battery cells 507 and 508, and when on connects that point to the high line 551 of the first rail and the low line 557 of the second rail. Switch 545 is electrically connected between battery cells 508 and 509, and when on connects that point to the high line 556 of the second rail and the low line 552 of the first rail.

Switch 546 is electrically connected between battery cells 509 and 510, and when on connects that point to the high line 551 of the first rail and the low line 557 of the second rail. Switch 547 is electrically connected to the high potential side of battery cell 510, and when on connects that point to the high line 556 of the second rail.

Switch 549, when on, connects the high line 551 of the first rail to switches 565, 567 and 568. Switch 550, when on, connects the low line 552 of the first rail to switches 566 and 567 and to DC/DC converter 580. A 10 Ohm resistor is between switches 550 and 567. Switch 554, when on, connects the high line 556 of the second rail to switches 565, 567 and 568. Switch 555, when on, connects the low line 557 of the second rail to switches 566 and 567 and to DC/DC converter 580. A 10 Ohm resistor is between switches 555 and 567. The DC/DC converter 580 is also connected to a voltage source. Switch 565, when on, connects switches 549 and 554 to a high input of voltage differentiator 581. Switch 566, when on, connects switches 550 and 555 to a low input of voltage differentiator 581. Switch 567, when on, connects switches 549 and 554 to switches 550 and 555. Switch 568, when on, connects switches 549 and 554 to DC/DC converter 580.

Input 558 connects to AND gates 560 and 562. Input 558 also connects to NOT gate 563, which connects to AND gate 561. Input 559 connects to AND gates 560 and 561. Input 559 also connects to NOT gate 564, which connects to AND gate 561. The output from AND gate 560 controls switches 565 and 566. The output from AND gate 561 controls switch 568, and the output from AND gate 562 controls switch 567.

Behavior of decoder 515 is described in the following table:

| 514 | 513 | 512 | 511 | 516 | 517 | 518 | 519 | 520 | 521 | 522 | 523 | 524 | 525 |
|---|---|---|---|---|---|---|---|---|---|---|---|---|---|
| 0 | 0 | 0 | 0 | 1 | 0 | 0 | 0 | 0 | 0 | 0 | 0 | 0 | 0 |
| 0 | 0 | 0 | 1 | 0 | 1 | 0 | 0 | 0 | 0 | 0 | 0 | 0 | 0 |
| 0 | 0 | 1 | 0 | 0 | 0 | 1 | 0 | 0 | 0 | 0 | 0 | 0 | 0 |
| 0 | 0 | 1 | 1 | 0 | 0 | 0 | 1 | 0 | 0 | 0 | 0 | 0 | 0 |
| 0 | 1 | 0 | 0 | 0 | 0 | 0 | 0 | 1 | 0 | 0 | 0 | 0 | 0 |
| 0 | 1 | 0 | 1 | 0 | 0 | 0 | 0 | 0 | 1 | 0 | 0 | 0 | 0 |
| 0 | 1 | 1 | 0 | 0 | 0 | 0 | 0 | 0 | 0 | 1 | 0 | 0 | 0 |
| 0 | 1 | 1 | 1 | 0 | 0 | 0 | 0 | 0 | 0 | 0 | 1 | 0 | 0 |
| 1 | 0 | 0 | 0 | 0 | 0 | 0 | 0 | 0 | 0 | 0 | 0 | 1 | 0 |
| 1 | 0 | 0 | 1 | 0 | 0 | 0 | 0 | 0 | 0 | 0 | 0 | 0 | 1 |

Selection between the first and second rails is described in the following table:

| 548 | 553 | Selection of rail |
|---|---|---|
| 0 | 0 | All “OFF”-RESET |
| 0 | 1 | Select the odd cells |
| 1 | 0 | Select the even cells |
| 1 | 1 | Prohibited |

Selection between BMS functions is described in the following table:

| 558 | 559 | Selection of function |
|---|---|---|
| 0 | 0 | All “OFF”-RESET |
| 0 | 1 | Boost the selected cell |
| 1 | 0 | Buck the selected cell |
| 1 | 1 | Read the selected cell |

Module with 8 Bit Control Logic and PLA or EPROM

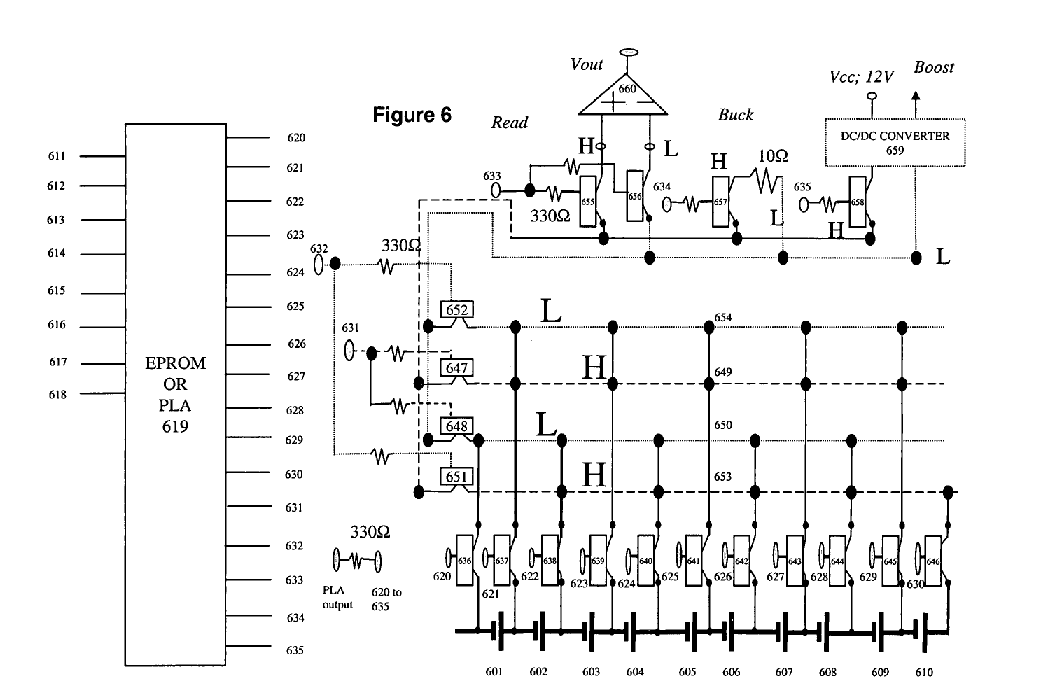

FIG. 6 illustrates a BMS module that is controlled by an 8 bit control logic together with a PLA or EPROM in accordance with one embodiment of the present invention. The system has battery cells 601 through 610 in series and 8 control inputs. Inputs 611 to 618 connect to PLA or EPROM 619. PLA or EPROM 619 has outputs 620 to 635. Outputs 620 to 630 control switches 636 to 646, respectively.

Output 631 controls switches 647 and 648 of a first rail having a high line 649 and low line 650. Output 632 controls switches 651 and 652 of a second rail having a high line 653 and low line 654. Output 633 controls switches 655 and 656. Output 634 controls switch 657. Output 635 controls switch 658.

Switch 636 is electrically connected to the low potential side of battery cell 601 and when on connects that point to the low line 650 of the first rail. Switch 637 is electrically connected between battery cells 601 and 602, and when on connects that point to the high line 649 of the first rail and the low line 654 of the second rail. Switch 638 is electrically connected between battery cells 602 and 603, and when on connects that point to the high line 653 of the second rail and the low line 650 of the first rail. Switch 639 is electrically connected between battery cells 603 and 604, and when on connects that point to the high line 649 of the first rail and the low line 654 of the second rail. Switch 640 is electrically connected between battery cells 604 and 605, and when on connects that point to the high line 653 of the second rail and the low line 650 of the first rail.

Switch 641 is electrically connected between battery cells 605 and 606, and when on connects that point to the high line 649 of the first rail and the low line 654 of the second rail. Switch 642 is electrically connected between battery cells 606 and 607, and when on connects that point to the high line 653 of the second rail and the low line 650 of the first rail. Switch 643 is electrically connected between battery cells 607 and 608, and when on connects that point to the high line 649 of the first rail and the low line 654 of the second rail. Switch 644 is electrically connected between battery cells 608 and 609, and when on connects that point to the high line 653 of the second rail and the low line 650 of the first rail.

Switch 645 is electrically connected between battery cells 609 and 610, and when on connects that point to the high line 649 of the first rail and the low line 654 of the second rail. Switch 646 is electrically connected to the high potential side of battery cell 610, and when on connects that point to the high line 653 of the second rail.

Switch 647, when on, connects the high line 649 of the first rail to switches 655, 657 and 658. Switch 648, when on, connects the low line 650 of the first rail to switches 656 and 657 and to DC/DC converter 659. A 10 Ohm resistor is between switches 648 and 657. Switch 651, when on, connects the high line 653 of the second rail to switches 655, 657 and 658. Switch 652, when on, connects the low line 654 of the second rail to switches 656 and 657 and to DC/DC converter 659. A 10 Ohm resistor is between switches 652 and 657. The DC/DC converter 659 is also connected to a voltage source.

Switch 655, when on, connects switches 647 and 651 to a high input of voltage differentiator 660. Switch 656, when on, connects switches 648 and 652 to a low input of voltage differentiator 660. Switch 657, when on, connects switches 647 and 651 to switches 648 and 652. Switch 658, when on, connects switches 647 and 651 to DC/DC converter 659. Appendix B illustrates bit patterns and timing values for controlling a 40 cell system with 4 modules like the one in FIG. 6. Each module can operate independently. For example, one module can be reading its cell 4 while another module is bucking its cell 9.

Quicker Response Times Using SSRs

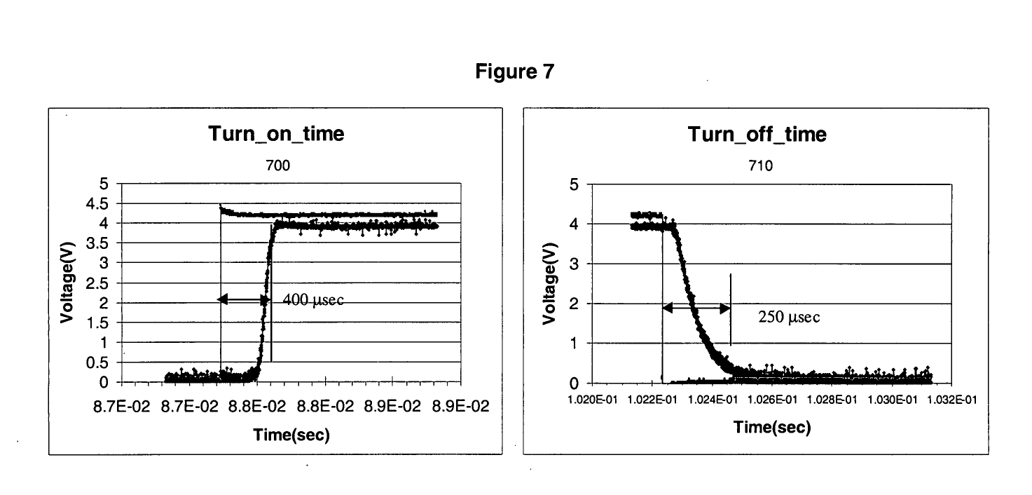

FIG. 7 illustrates the response times achieved using SSRs in a BMS in accordance with one embodiment of the present invention. Graph 700 illustrates the turn on response time of 400 microseconds. Graph 710 illustrates the turn off response time of 250 microseconds. The response times are sufficiently speedy to enable one embodiment to read, boost and/or buck each battery cell each second.

Thus, a method and apparatus for multiple battery cell management is described in conjunction with one or more specific embodiments. The invention is defined by the following claims and their full scope and equivalents.

1. A method for managing a battery system comprising:
using a solid state relay as a switch during an operation of said battery system.

2. The method of claim 1 wherein said solid state relay is an optically isolated field-effect transistor.

3. The method of claim 1 wherein said operation is a read and wherein said switch completes a circuit comprising:
a side of a battery cell; and
an input of a voltage differentiator.

4. The method of claim 1 wherein said operation is a buck and wherein said switch completes a circuit comprising:
a first side of a battery cell;
a resistor; and
a second side of a battery cell.

5. The method of claim 1 wherein said operation is a boost and wherein said switch completes a circuit comprising:
a side of a battery cell; and
a voltage source.

6. The method of claim 1 further comprising:
controlling said battery system using a logic circuit.

7. The method of claim 1 further comprising:
controlling said battery system using an EPROM.

8. The method of claim 1 further comprising:
controlling said battery system using a programmable logic array.

9. The method of claim 1 wherein a control circuit that controls said switch is protected from a higher voltage circuit wherein said switch-is a component of said higher voltage circuit.

10. A method of managing a battery system comprising:
providing a first rail; and
providing a second rail;

11. The method of claim 10 further comprising:
providing a first switch connected to a high line of said first rail;
providing a second switch connected to a low line of said first rail;
providing a third switch connected to a high line of said second rail; and
providing a fourth switch connected to a low line of said second rail.

12. The method of claim 10 further comprising:
partitioning a first battery cell into a first battery group;
partitioning a second battery cell into a second battery group wherein said second battery cell is in series with said first battery cell and wherein a first side of said first battery cell is electrically connected to a first side of said second battery cell; and
accessing said first side of said first battery cell and a second side of said first battery cell using said first rail.

13. The method of claim 12 further comprising:
accessing said first side of said second battery cell and a second side of said second battery cell using said second rail.

14. A method of managing a battery system comprising:
partitioning a plurality of battery cells into a plurality of battery cell groups;
controlling battery management functions of a first battery cell group using a battery management control module.

15. The method of claim 14 wherein said battery management control module is controlled by a 16-bit control input.

16. The method of claim 14 wherein said battery management control module is controlled by a 8-bit control input.

17. The method of claim 14 wherein four battery management control modules are used to control battery management functions of four battery cell groups.

18. The method of claim 14 wherein a first battery cell group has ten battery cells.

19. A battery management system comprising:
a solid state relay configured to function as a switch during an operation of said battery management system.

20. The battery management system of claim 19 wherein said solid state relay is an optically isolated field-effect transistor.

21. The battery management system of claim 19 wherein said operation is a read and wherein said solid state relay completes a circuit comprising:
a side of a battery cell; and
an input of a voltage differentiator.

22. The battery management system of claim 19 wherein said operation is a buck and wherein said solid state relay completes a circuit comprising:
a first side of a battery cell;
a resistor; and
a second side of a battery cell.

23. The battery management system of claim 19 wherein said operation is a boost and wherein said solid state relay completes a circuit comprising:
a side of a battery cell; and
a voltage source.

24. The battery management system of claim 19 further comprising:
a logic circuit configured to control said battery management system.

25. The battery management system of claim 19 further comprising:
an EPROM configured to control said battery management system.

26. The battery management system of claim 19 further comprising:
a programmable logic array configured to control said battery management system.

27. The battery management system of claim 19 further comprising:
a control circuit configured to control said solid state relay wherein said control circuit is protected from a higher voltage circuit and wherein said solid state relay is a component of said higher voltage circuit.

28. A battery management system comprising:
a first rail; and
a second rail;

29. The battery management system of claim 28 further comprising:
a first switch connected to a high line of said first rail;
a second switch connected to a low line of said first rail;
a third switch connected to a high line of said second rail; and
a fourth switch connected to a low line of said second rail.

30. The battery management system of claim 28 further comprising:
a partitioning unit configured to partition a first battery cell into a first battery group wherein said partitioning unit is further configured to partition a second battery cell into a second battery group wherein said second battery cell is in series with said first battery cell and wherein a first side of said first battery cell is electrically connected to a first side of said second battery cell; and
a control unit configured to access said first side of said first battery cell and a second side of said first battery cell using said first rail.

31. The battery management system of claim 30 further comprising:
a second control configured to access said first side of said second battery cell and a second side of said second battery cell using said second rail.

32. A battery management system comprising:
a partitioning unit configured to partition a plurality of battery cells into a plurality of battery cell groups;
a control unit configured to control battery management functions of a first battery cell group using a battery management control module.

33. The battery management system of claim 32 wherein said battery management control module is controlled by a 16-bit control input.

34. The battery management system of claim 32 wherein said battery management control module is controlled by a 8-bit control input.

35. The battery management system of claim 32 wherein four battery management control modules are used to control battery management functions of four battery cell groups.

36. The battery management system of claim 32 wherein a first battery cell group has ten battery cells.
